(19) United States
(12) Patent Application Publication
(10) Pub. No.: US 2025/0178874 A1
(43) Pub. Date: Jun. 5, 2025

(54) DENSE DATA REGISTRATION FROM AN ACTUATABLE VEHICLE-MOUNTED SENSOR

(71) Applicant: Seegrid Corporation, Pittsburgh, PA (US)

(72) Inventors: Bruce Thompson, Pittsburgh, PA (US); Nathan Greco, Beaver, PA (US); Blane Rhoads, Pittsburgh, PA (US); Gregory Kyle Jones, Pittsburgh, PA (US); John Spletzer, Nokomis, FL (US); Tom Panzarella, Haddonfield, NJ (US)

(21) Appl. No.: 18/842,163

(22) PCT Filed: Mar. 28, 2023
(86) PCT No.: PCT/US2023/016608

§ 371 Date: Aug. 28, 2024

Related U.S. Application Data
(60) Provisional application No. 63/324,185, filed on Mar. 28, 2022.

(51) Int. Cl. B66F 9/075; B66F 9/06

(52) U.S. Cl. CPC B66F 9/0755; B66F 9/063

(57) ABSTRACT

In accordance with one aspect of the inventive concepts, provided is an autonomous mobile robot (AMR), comprising: a carriage actuation and feedback system configured to robotically control a carriage to control a height of a pair of forks; at least one sensor configured to acquire sensor data over multiple planes in a direction of the forks during actuation of the carriage that raises and lowers the forks; an infrastructure localization system configured to combine the sensor data from the multiple planes into dense point cloud data and identify an infrastructure from the dense point cloud data. A method of localizing infrastructure using dense point cloud data is also provided.

### CROSS REFERENCE TO RELATED APPLICATIONS

The present application claims priority to U.S. Provisional Appl. 63/324,185 filed on Mar. 28, 2022, entitled Dense Data Registration From A Vehicle Mounted Sensor Via Existing Actuator, which is incorporated herein by reference in its entirety.

The present application may be related to U.S. Provisional Appl. 63/430,184 filed on Dec. 5, 2022, entitled Just in Time Destination Definition and Route Planning; U.S. Provisional Appl. 63/430,190 filed on Dec. 5, 2022, entitled Configuring a System that Handles Uncertainty with Human and Logic Collaboration in a Material Flow Automation Solution; U.S. Provisional Appl. 63/430,182 filed on Dec. 5, 2022, entitled Composable Patterns of Material Flow Logic for the Automation of Movement; U.S. Provisional Appl. 63/430,174 filed on Dec. 5, 2022, entitled Process Centric User Configurable Step Framework for Composing Material Flow Automation; U.S. Provisional Appl. 63/430,195 filed on Dec. 5, 2022, entitled Generation of “Plain Language” Descriptions Summary of Automation Logic; U.S. Provisional Appl. 63/430,171 filed on Dec. 5, 2022, entitled Hybrid Autonomous System Enabling and Tracking Human Integration into Automated Material Flow; U.S. Provisional Appl. 63/430,180 filed on Dec. 5, 2022, entitled A System for Process Flow Templating and Duplication of Tasks Within Material Flow Automation; U.S. Provisional Appl. 63/430,200 filed on Dec. 5, 2022, entitled A Method for Abstracting Integrations Between Industrial Controls and Autonomous Mobile Robots (AMRs); and U.S. Provisional Appl. 63/430,170 filed on Dec. 5, 2022, entitled Visualization of Physical Space Robot Queuing Areas as Non Work Locations for Robotic Operations, each of which is incorporated herein by reference in its entirety.

The present application may be related to U.S. Provisional Appl. 63/348,520 filed on Jun. 3, 2022, entitled System and Method for Generating Complex Runtime Path Networks from Incomplete Demonstration of Trained Activities; U.S. Provisional Appl. 63/410,355 filed on Sep. 27, 2022, entitled Dynamic, Deadlock-Free Hierarchical Spatial Mutexes Based on a Graph Network; U.S. Provisional Appl. 63/346,483 filed on May 27, 2022, entitled System and Method for Performing Interactions with Physical Objects Based on Fusion of Multiple Sensors; and U.S. Provisional Appl. 63/348,542 filed on Jun. 3, 2022, entitled Lane Grid Setup for Autonomous Mobile Robots (AMRs); U.S. Provisional Appl. 63/423,679, filed Nov. 8, 2022, entitled System and Method for Definition of a Zone of Dynamic Behavior with a Continuum of Possible Actions and Structural Locations within Same; U.S. Provisional Appl. 63/423,683, filed Nov. 8, 2022, entitled System and Method for Optimized Traffic Flow Through Intersections with Conditional Convoying Based on Path Network Analysis; U.S. Provisional Appl. 63/423,538, filed Nov. 8, 2022, entitled Method for Calibrating Planar Light-Curtain; each of which is incorporated herein by reference in its entirety.

The present application may be related to U.S. Provisional Appl. 63/324,182 filed on Mar. 28, 2022, entitled A Hybrid, Context-Aware Localization System For Ground Vehicles; U.S. Provisional Appl. 63/324,184 filed on Mar. 28, 2022, entitled Safety Field Switching Based On End Effector Conditions; U.S. Provisional Appl. 63/324,187 filed on Mar. 28, 2022, entitled Extrinsic Calibration Of A Vehicle-Mounted Sensor Using Natural Vehicle Features; U.S. Provisional Appl. 63/324,188 filed on Mar. 28, 2022, entitled Continuous And Discrete Estimation Of Payload Engagement Disengagement Sensing; U.S. Provisional Appl. 63/324,190 filed on Mar. 28, 2022, entitled Passively Actuated Sensor Deployment; U.S. Provisional Appl. 63/324,192 filed on Mar. 28, 2022, entitled Automated Identification Of Potential Obstructions In A Targeted Drop Zone; U.S. Provisional Appl. 63/324,193 filed on Mar. 28, 2022, entitled Localization Of Horizontal Infrastructure Using Point Clouds; U.S. Provisional Appl. 63/324,195 filed on Mar. 28, 2022, entitled Navigation Through Fusion of Multiple Localization Mechanisms and Fluid Transition Between Multiple Navigation Methods; U.S. Provisional Appl. 63/324,198 filed on Mar. 28, 2022, entitled Segmentation Of Detected Objects Into Obstructions And Allowed Objects; U.S. Provisional Appl. 62/324,199 filed on Mar. 28, 2022, entitled Validating The Pose Of An AMR That Allows It To Interact With An Object; and U.S. Provisional Appl. 63/324,201 filed on Mar. 28, 2022, entitled A System For AMRs That Leverages Priors When Localizing Industrial Infrastructure; each of which is incorporated herein by reference in its entirety.

The present application may be related to U.S. patent application Ser. No. 11/350,195, filed on Feb. 8, 2006, U.S. Pat. No. 7,446,766, Issued on Nov. 4, 2008, entitled Multidimensional Evidence Grids and System and Methods for Applying Same; U.S. patent application Ser. No. 12/263,983 filed on Nov. 3, 2008, U.S. Pat. No. 8,427,472, Issued on Apr. 23, 2013, entitled Multidimensional Evidence Grids and System and Methods for Applying Same; U.S. patent application Ser. No. 11/760,859, filed on Jun. 11, 2007, U.S. Pat. No. 7,880,637, Issued on Feb. 1, 2011, entitled Low-Profile Signal Device and Method For Providing Color-Coded Signals; U.S. patent application Ser. No. 12/361,300 filed on Jan. 28, 2009, U.S. Pat. No. 8,892,256, Issued on Nov. 18, 2014, entitled Methods For Real-Time and Near-Real Time Interactions With Robots That Service A Facility; U.S. patent application Ser. No. 12/361,441, filed on Jan. 28, 2009, U.S. Pat. No. 8,838,268, Issued on Sep. 16, 2014, entitled Service Robot And Method Of Operating Same; U.S. patent application Ser. No. 14/487,860, filed on Sep. 16, 2014, U.S. Pat. No. 9,603,499, Issued on Mar. 28, 2017, entitled Service Robot And Method Of Operating Same; U.S. patent application Ser. No. 12/361,379, filed on Jan. 28, 2009, U.S. Pat. No. 8,433,442, Issued on Apr. 30, 2013, entitled Methods For Repurposing Temporal-Spatial Information Collected By Service Robots; U.S. patent application Ser. No. 12/371,281, filed on Feb. 13, 2009, U.S. Pat. No. 8,755,936, Issued on Jun. 17, 2014, entitled Distributed Multi-Robot System; U.S. patent application Ser. No. 12/542,279, filed on Aug. 17, 2009, U.S. Pat. No. 8,169,596, Issued on May 1, 2012, entitled System And Method Using A Multi-Plane Curtain; U.S. patent application Ser. No. 13/460,096, filed on Apr. 30, 2012, U.S. Pat. No. 9,310,608, Issued on Apr. 12, 2016, entitled System And Method Using A Multi-Plane Curtain; U.S. patent application Ser. No. 15/096,748, filed on Apr. 12, 2016, U.S. Pat. No. 9,910,137, Issued on Mar. 6, 2018, entitled System and Method Using A Multi-Plane Curtain; U.S. patent application Ser. No. 13/530,876, filed on Jun. 22, 2012, U.S. Pat. No. 8,892,241, Issued on Nov. 18, 2014, entitled Robot-Enabled Case Picking; U.S. patent application Ser. No. 14/543,241, filed on Nov. 17, 2014, U.S. Pat. No. 9,592,961, Issued on Mar. 14, 2017, entitled Robot-Enabled Case Picking; U.S. patent application Ser. No. 13/168,639, filed on Jun. 24, 2011, U.S. Pat. No. 8,864,164, Issued on Oct. 21, 2014, entitled Tugger Attachment; U.S. Design patent application Ser. No. 29/398,127, filed on Jul. 26, 2011, U.S. Patent Number D680,142, Issued on Apr. 16, 2013, entitled Multi-Camera Head; U.S. Design patent application Ser. No. 29/471,328, filed on Oct. 30, 2013, U.S. Patent Number D730,847, Issued on Jun. 2, 2015, entitled Vehicle Interface Module; U.S. patent application Ser. No. 14/196,147, filed on Mar. 4, 2014, U.S. Pat. No. 9,965,856, Issued on May 8, 2018, entitled Ranging Cameras Using A Common Substrate; U.S. patent application Ser. No. 16/103,389, filed on Aug. 14, 2018, U.S. Pat. No. 11,292,498, Issued on Apr. 5, 2022, entitled Laterally Operating Payload Handling Device; U.S. patent application Ser. No. 16/892,549, filed on Jun. 4, 2020, U.S. Publication Number 2020/0387154, Published on Dec. 10, 2020, entitled Dynamic Allocation And Coordination of Auto-Navigating Vehicles and Selectors; U.S. patent application Ser. No. 17/163,973, filed on Feb. 1, 2021, U.S. Publication Number 2021/0237596, Published on Aug. 5, 2021, entitled Vehicle Auto-Charging System and Method; U.S. patent application Ser. No. 17/197,516, filed on Mar. 10, 2021, U.S. Publication Number 2021/0284198, Published on Sep. 16, 2021, entitled Self-Driving Vehicle Path Adaptation System and Method; U.S. patent application Ser. No. 17/490,345, filed on Sep. 30, 2021, U.S. Publication Number 2022-0100195, published on Mar. 31, 2022, entitled Vehicle Object-Engagement Scanning System And Method; U.S. patent application Ser. No. 17/478,338, filed on Sep. 17, 2021, U.S. Publication Number 2022-0088980, published on Mar. 24, 2022, entitled Mechanically-Adaptable Hitch Guide each of which is incorporated herein by reference in its entirety.

### FIELD OF INTEREST

The present inventive concepts relate to the field of autonomous and/or robotic vehicles. Aspects of the inventive concepts are applicable to any mobile robotics application involving manipulation. More specifically, the present inventive concepts relate to systems and methods of data registration during sensor actuation.

### BACKGROUND

In order for a mobile robot to detect multiple types of infrastructure precisely, a dense point cloud is needed, but available sensors are too sparse, particularly when scan planes are parallel to a surface that is being looked for. Adding additional hardware, increases cost of goods sold (COGS) and complexity. Existing mobile robots mount a sensor on a dedicated actuator so that the sensor, e.g., a LiDAR scanner, collects data coordinated with motion isolated to the sensor alone. This is not sufficient for acquiring a dense point cloud to accurately detect multiple types of infrastructure. By leveraging an existing actuator the same benefit can be realized without the additional cost and complexity.

### SUMMARY OF THE INVENTION

In accordance with one aspect of the inventive concepts, provided is an autonomous mobile robot (AMR), comprising: a carriage actuation and feedback system configured to robotically control a carriage to control a height of a pair of fork tines; at least one sensor configured to acquire sensor data over multiple planes, or a single plane, in a direction of the forks during actuation of the carriage that raises and lowers the forks; and an infrastructure localization system configured to combine the sensor data from the multiple planes into dense point cloud data and identify an infrastructure from the dense point cloud data.

In various embodiments, the infrastructure localization system is configured to transform sensor data for individual poses of the infrastructure to a common frame of reference to combine the sensor data from the multiple planes.

In various embodiments, the at least one sensor includes a sensor that is located between the forks and is downwardly directed to acquire the sensor data beneath the raised forks.

In various embodiments, the carriage actuation and feedback system includes a hard stop that sets a lower limit for the height of the at least one sensor when the forks are raised.

In various embodiments, the at least one sensor includes a sensor that is located beneath the raised forks.

In various embodiments, the at least one sensor includes a sensor that is located above the forks when the forks are lowered.

In various embodiments, the at least one sensor comprises a multi-ring LiDAR sensor.

In various embodiments, the AMR further comprises a passive sensor deployment system configured to operatively move the at least one sensor in response to movement of the forks.

In various embodiments, movement of the carriage triggers the carriage actuation and position feedback system to acquire position, velocity, and/or acceleration data of the carriage, wherein the infrastructure localization system is configured to combine the sensor data from the multiple planes into the dense point cloud data based at least in part on the position, velocity, and/or acceleration data of the carriage.

In various embodiments, the carriage actuation and position feedback system comprises a closed-loop hydraulics controller.

In various embodiments, the infrastructure localization system is configured to provide interpolation of carriage position to determine sensor position for each scan.

In accordance with another aspect of the inventive concepts, provided is a method of localizing infrastructure in an autonomous mobile robot (AMR), comprising: providing an AMR having a pair of forks coupled to a carriage that is height adjustable and at least one sensor oriented in the direction of the forks; acquiring sensor data in multiple planes with the at least one sensor during actuation of a forklift carriage that raises and lowers the forks; and combining the sensor data from the multiple planes into dense point cloud data and identifying an infrastructure from the dense point cloud data.

In various embodiments, the method further comprises transforming sensor data for individual poses of the infrastructure to a common frame of reference to combine the sensor data from the multiple planes.

In various embodiments, the at least one sensor includes a sensor that is located between the forks and is downwardly directed to acquire the sensor data beneath the raised forks.

In various embodiments, the AMR includes a hard stop that sets a lower limit for the height of the at least one sensor when the forks are raised.

In various embodiments, the at least one sensor includes a sensor that is located beneath the raised forks.

In various embodiments, the at least one sensor includes a sensor that is located above the forks when the forks are lowered.

In various embodiments, the at least one sensor comprises a multi-ring LiDAR sensor.

In various embodiments, the method further comprises passively deploying the at least one sensor using onboard actuators in response to movement of the forks.

In various embodiments, the method further comprises, in response to movement of the carriage, acquiring position, velocity, and/or acceleration data of the carriage, and wherein combining the sensor data from the multiple planes into the dense point cloud data based at least in part on the position, velocity, and/or acceleration data of the carriage.

In various embodiments, the method further comprises controlling the carriage height based on the sensor data with a closed-loop hydraulics controller.

In various embodiments, the method further comprises interpolating carriage position to determine sensor position for each scan.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. In the drawings:

FIG. 1A provides a perspective view of a robotic vehicle in accordance with aspects of the inventive concepts.

FIG. 1B provides a side view of a robotic vehicle with its load engagement portion retracted, in accordance with aspects of the inventive concepts.

FIG. 1C provides a side view of a robotic vehicle with its load engagement portion extended, in accordance with aspects of the inventive concepts.

FIG. 1D provides another perspective view of a robotic vehicle in accordance with aspects of the inventive concepts.

FIG. 1E provides a front perspective view of a robotic vehicle in accordance with aspects of the inventive concepts.

FIG. 2 illustrates an embodiment of a multi-horizontal scan plane LiDAR sensor with sparse vertical point density passing over a face of a table, pallet, and payload while a forklift is actuating upwards.

FIG. 3A is a close-up view of an embodiment of a sensor of an AMR deployed with forks partially raised, in accordance with aspects of the inventive concepts.

FIG. 3B is a close-up view of an embodiment of a sensor of an AMR stowed with forks fully lowered, in accordance with aspects of the inventive concepts.

FIG. 3C is a close-up view of an embodiment of a sensor of an AMR deployed with forks raised to payload carry height, in accordance with aspects of the inventive concepts.

FIG. 4 is an image of a dense point cloud representation of a structure using a vehicle-mounted actuatable sensor, in accordance with aspects of the inventive concepts.

FIG. 5 is a block diagram of a method of localizing infrastructure using dense point cloud data from a vehicle-mounted actuatable sensor, in accordance with the inventive concepts.

### DESCRIPTION OF PREFERRED EMBODIMENT

It will be understood that, although the terms first, second, etc. may be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements may be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

In the context of the inventive concepts, and unless otherwise explicitly indicated, a “real-time” action is one that occurs while the AMR is in-service and performing normal operations. This is typically in immediate response to new sensor data or triggered by some other event. The output of an operation performed in real-time will take effect upon the system so as to minimize any latency.

In accordance with aspects of the inventive concepts, provided are systems and methods that provide servo-driven 3D point cloud data aggregation, in accordance with aspects of the inventive concepts. In some embodiments, the inventive concepts can be implemented with autonomous mobile robots (AMRs) configured to provide a dense point cloud from a single sensor to enable precise infrastructure localization without driving up cost of goods sold (COGS).

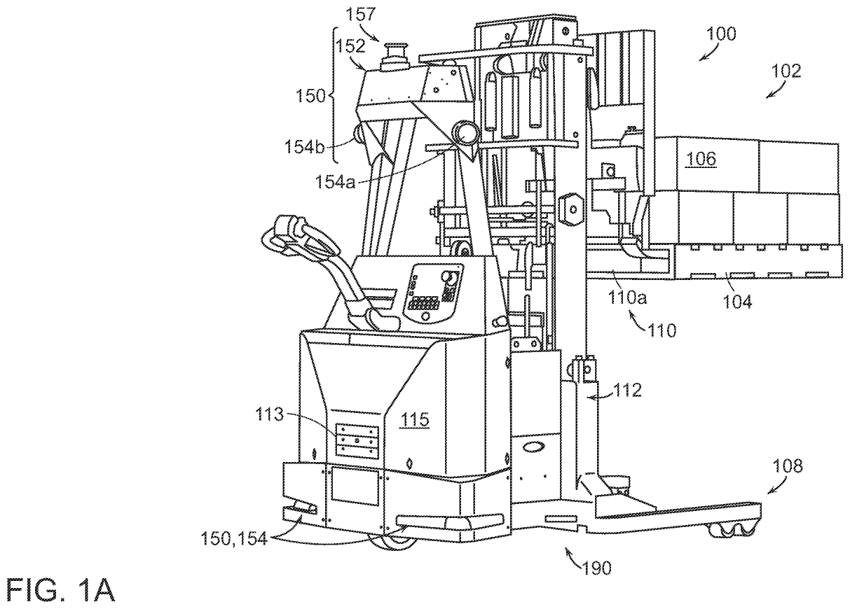

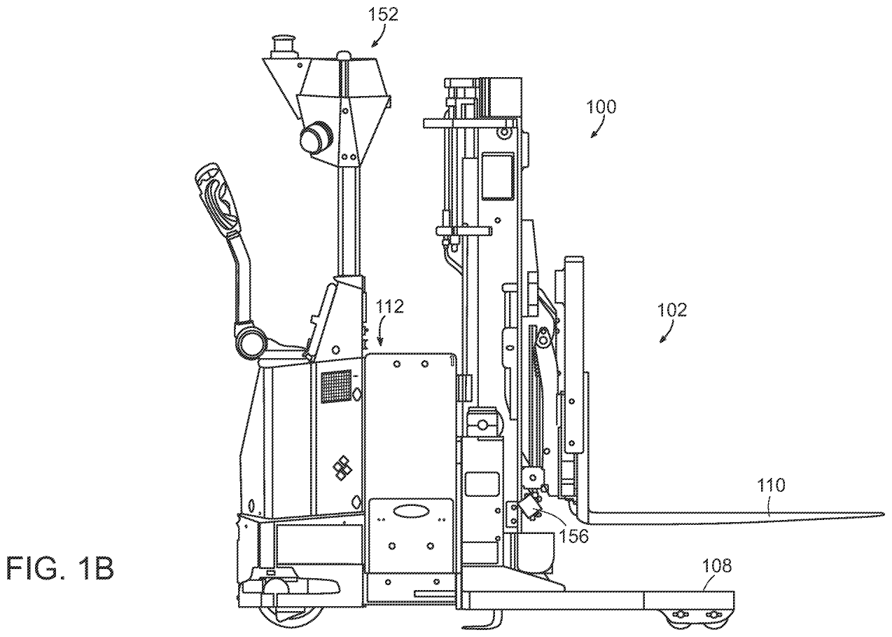

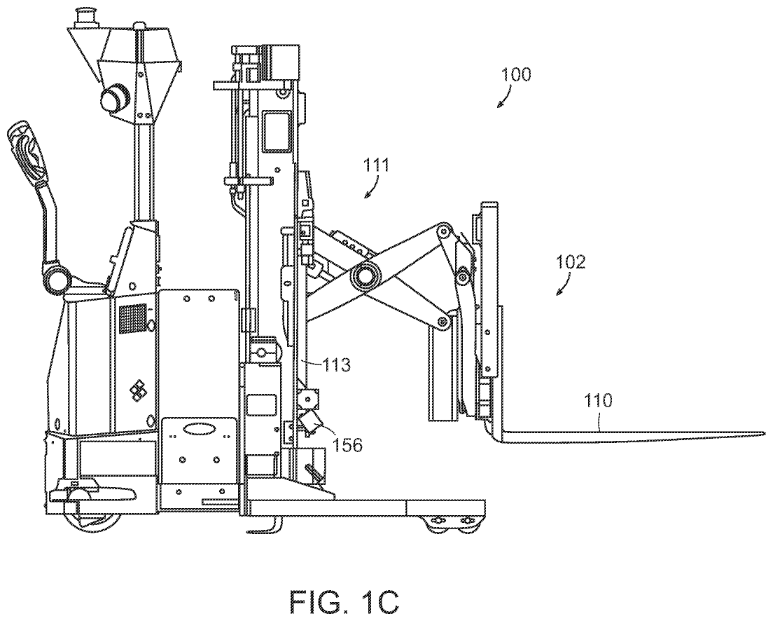

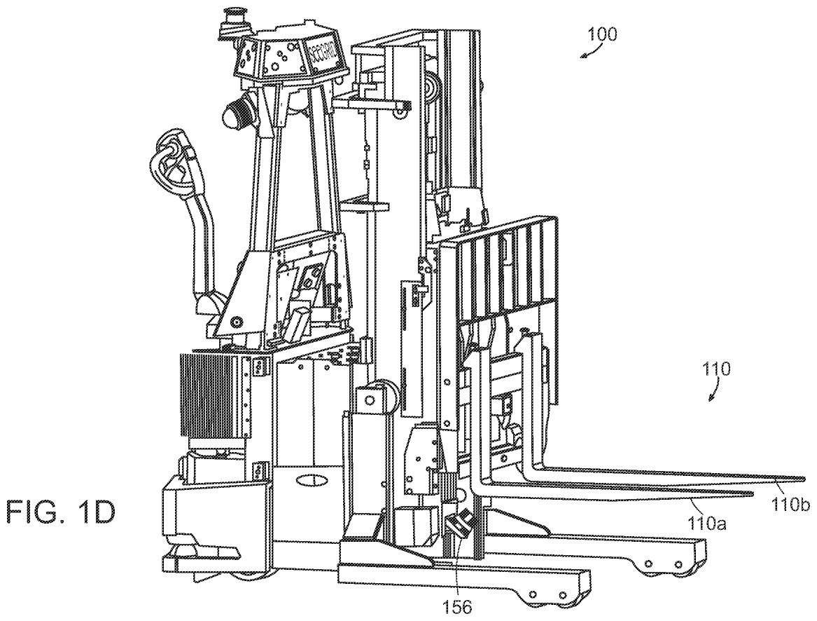

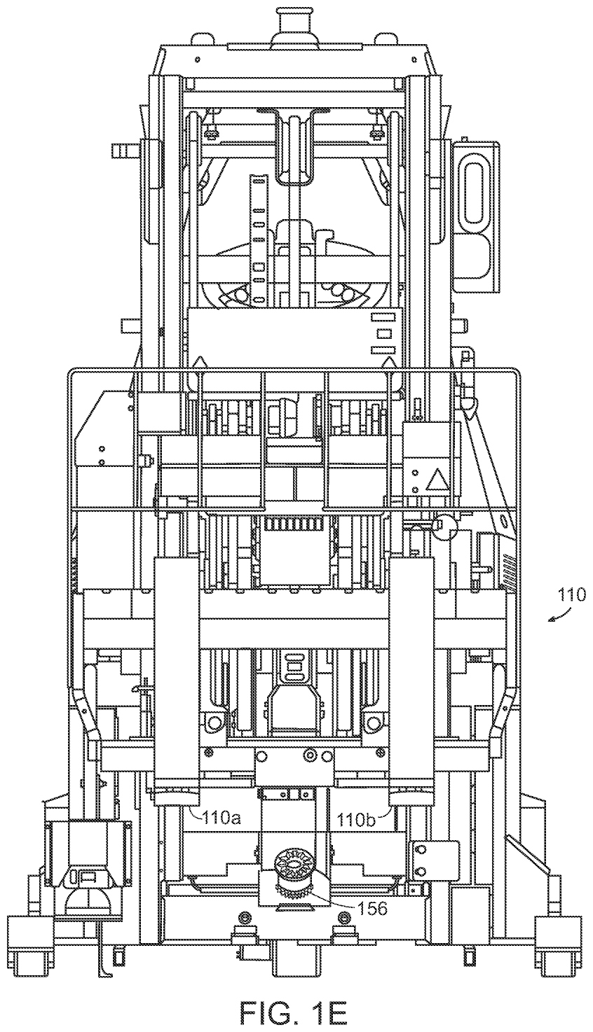

Referring to FIGS. 1A through 1E, collectively referred to as FIG. 1, shown is an example of a robotic vehicle 100 in the form of an AMR forklift 100 that can be configured with the sensing, processing, and memory devices and subsystems necessary and/or useful for performing methods of provide servo-driven data aggregation, in accordance with aspects of the inventive concepts. In this embodiment, the robotic vehicle 100 takes the form of an AMR pallet lift, but the inventive concepts could be embodied in any of a variety of other types of robotic vehicles and AMRs, including, but not limited to, pallet trucks, tuggers, and the like. In some embodiments, robotic vehicles described herein can employ Linux, Robot Operating System ROS2, and related libraries, which are commercially available and known in the art.

In this embodiment, the robotic vehicle 100 includes a payload area 102 configured to transport a pallet 104 loaded with goods, which collectively form a palletized payload 103. To engage and carry the pallet 104, the robotic vehicle may include a pair of forks 110, including a first and second forks 110a,b. Outriggers 108 extend from a chassis 190 of the robotic vehicle in the direction of the forks to stabilize the vehicle, particularly when carrying the palletized load. The robotic vehicle 100 can comprise a battery area 112 for holding one or more batteries. In various embodiments, the one or more batteries can be configured for charging via a charging interface 113. The robotic vehicle 100 can also include a main housing 115 within which various control elements and subsystems can be disposed, including those that enable the robotic vehicle to navigate from place to place.

The forks 110 may be supported by one or more robotically controlled actuators 111 coupled to a carriage 113 that enable the robotic vehicle 100 to raise and lower and extend and retract to pick up and drop off loads, e.g., palletized loads 106. In various embodiments, the robotic vehicle may be configured to robotically control the yaw, pitch, and/or roll of the forks 110 to pick a palletized load in view of the pose of the load and/or horizontal surface that supports the load. In various embodiments, the robotic vehicle may be configured to robotically control the yaw, pitch, and/or roll of the forks 110 to pick a palletized load in view of the pose of the horizontal surface that is to receive the load.

The robotic vehicle 100 may include a plurality of sensors 150 that provide various forms of sensor data that enable the robotic vehicle to safely navigate throughout an environment, engage with objects to be transported, and avoid obstructions. In various embodiments, the sensor data from one or more of the sensors 150 can be used for path navigation and obstruction detection and avoidance, including avoidance of detected objects, hazards, humans, other robotic vehicles, and/or congestion during navigation.

One or more of the sensors 150 can form part of a two-dimensional (2D) or three-dimensional (3D) high-resolution imaging system used for navigation and/or object detection. In some embodiments, one or more of the sensors can be used to collect sensor data used to represent the environment and objects therein using point clouds to form a 3D evidence grid of the space, each point in the point cloud representing a probability of occupancy of a real-world object at that point in 3D space.

In computer vision and robotic vehicles, a typical task is to identify specific objects in an image and to determine each object's position and orientation relative to a coordinate system. This information, which is a form of sensor data, can then be used, for example, to allow a robotic vehicle to manipulate an object or to avoid moving into the object. The combination of position and orientation is referred to as the “pose” of an object. The image data from which the pose of an object is determined can be either a single image, a stereo image pair, or an image sequence where, typically, the camera as a sensor 150 is moving with a known velocity as part of the robotic vehicle.

The sensors 150 can include one or more stereo cameras 152 and/or other volumetric sensors, sonar sensors, radars, and/or laser imaging, detection, and ranging (LiDAR) scanners or sensors 154, as examples. Inventive concepts are not limited to particular types of sensors. In various embodiments, sensor data from one or more of the sensors 150, e.g., one or more stereo cameras 152 and/or LiDAR scanners 154, can be used to generate and/or update a 2-dimensional or 3-dimensional model or map of the environment, and sensor data from one or more of the sensors 150 can be used for the determining location of the robotic vehicle 100 within the environment relative to the electronic map of the environment.

In the embodiment shown in FIG. 1A, there are two LiDAR devices 154a, 154b positioned at the top of the robotic vehicle 100. In the embodiment shown in FIG. 1A, one of the LiDAR devices near the top of the robotic vehicle 154a is a 2D LiDAR device. In the embodiment shown in FIG. 1A, one of the LiDAR devices near the top of the robotic vehicle 154a is a 3D LiDAR device. In alternative embodiments, a different number of 2D LiDAR devices are positioned near the top of the robotic vehicle 100. In alternative embodiments, a different number of 3D LiDAR devices are positioned near the top of the robotic vehicle 100. In the embodiment shown in FIG. 1A, there is a sensor 157, for example, a 2D LiDAR, positioned at the top of the robotic vehicle 100 that can be used in vehicle localization.

In some embodiments, the sensors 150 can include sensors configured to detect objects in the payload area and/or behind the forks 110a,b. The sensors can be used in combination with others of the sensors, e.g., stereo camera head 152. In some embodiments, the sensors 150 can include one or more carriage sensors 156 oriented to collected 3D sensor data of the payload area 102 and/or forks 110. The carriage sensors 156 can include a 3D camera and/or a LiDAR scanner, as examples. In some embodiments, the carriage sensors 156 can be coupled to the robotic vehicle 100 so that they move in response to movement of the actuators 111 and/or fork 110. For example, in some embodiments, the carriage sensor 156 can be slidingly coupled to the carriage 113 so that the payload area sensors move in response to up and down and/or extension and retraction movement of the forks. In some embodiments, the carriage sensors collect 3D sensor data as they move with the forks.

Examples of stereo cameras arranged to provide 3-dimensional vision systems for a vehicle, which may operate at any of a variety of wavelengths, are described, for example, in U.S. Pat. No. 7,446,766, entitled Multidimensional Evidence Grids and System and Methods for Applying Same and U.S. Pat. No. 8,427,472, entitled Multi-Dimensional Evidence Grids, which are hereby incorporated by reference in their entirety. LiDAR systems arranged to provide light curtains, and their operation in vehicular applications, are described, for example, in U.S. Pat. No. 8,169,596, entitled System and Method Using a Multi-Plane Curtain, which is hereby incorporated by reference in its entirety.

In some embodiments, the sensors 150 can include sensors configured to detect objects in the payload area and/or behind the forks 110a,b. The sensors can be used in combination with others of the sensors, e.g., stereo camera head 152.

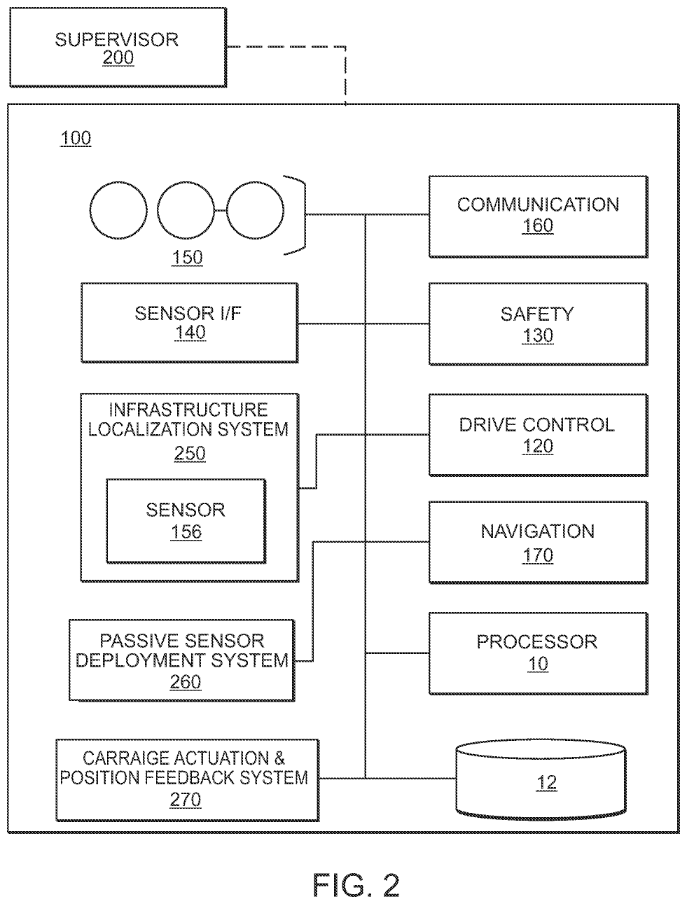

FIG. 2 is a block diagram of components of an embodiment of the robotic vehicle 100 of FIG. 1, incorporating technology for dense data registration from a vehicle mounted sensor via at least one existing actuator, in accordance with principles of inventive concepts. The embodiment of FIG. 2 is an example; other embodiments of the robotic vehicle 100 can include other components and/or terminology. In the example embodiment shown in FIGS. 1 and 2, the robotic vehicle 100 is a warehouse robotic vehicle, which can interface and exchange information with one or more external systems, including a supervisor system, fleet management system, and/or warehouse management system (collectively “supervisor 200”). In various embodiments, the supervisor 200 could be configured to perform, for example, fleet management and monitoring for a plurality of vehicles (e.g., AMRs) and, optionally, other assets within the environment. The supervisor 200 can be local or remote to the environment, or some combination thereof.

In various embodiments, the supervisor 200 can be configured to provide instructions and data to the robotic vehicle 100 and/or to monitor the navigation and activity of the robotic vehicle and, optionally, other robotic vehicles. The robotic vehicle can include a communication module 160 configured to enable communications with the supervisor 200 and/or any other external systems. The communication module 160 can include hardware, software, firmware, receivers and transmitters that enable communication with the supervisor 200 and any other internal or external systems over any now known or hereafter developed communication technology, such as various types of wireless technology including, but not limited to, WiFi, Bluetooth, cellular, global positioning system (GPS), radio frequency (RF), and so on.

As an example, the supervisor 200 could wirelessly communicate a path for the robotic vehicle 100 to navigate for the vehicle to perform a task or series of tasks. The path can be relative to a map of the environment stored in memory and, optionally, updated from time-to-time, e.g., in real-time, from vehicle sensor data collected in real-time as the robotic vehicle 100 navigates and/or preforms its tasks. The sensor data can include sensor data from one or more of the various sensors 150. As an example, in a warehouse setting the path could include one or more stops along a route for the picking and/or the dropping of goods. The path can include a plurality of path segments. The navigation from one stop to another can comprise one or more path segments. The supervisor 200 can also monitor the robotic vehicle 100, such as to determine robotic vehicle's location within an environment, battery status and/or fuel level, and/or other operating, vehicle, performance, and/or load parameters.

In example embodiments, a path may be developed by “training” the robotic vehicle 100. That is, an operator may guide the robotic vehicle 100 through a path within the environment while the robotic vehicle, through a machine-learning process, learns and stores the path for use in task performance and builds and/or updates an electronic map of the environment as it navigates. The path may be stored for future use and may be updated, for example, to include more, less, or different locations, or to otherwise revise the path and/or path segments, as examples. The path may include one or more pick and/or drop locations, and could include battery charging stops.

As is shown in FIG. 2, in example embodiments, the robotic vehicle 100 includes various functional elements, e.g., components and/or modules, which can be housed within the housing 115. Such functional elements can include at least one processor 10 coupled to at least one memory 12 to cooperatively operate the vehicle and execute its functions or tasks. The memory 12 can include computer program instructions, e.g., in the form of a computer program product, executable by the processor 10. The memory 12 can also store various types of data and information. Such data and information can include route data, path data, path segment data, pick data, location data, environmental data, and/or sensor data, as examples, as well as an electronic map of the environment.

In this embodiment, the processor 10 and memory 12 are shown onboard the robotic vehicle 100 of FIG. 1, but external (offboard) processors, memory, and/or computer program code could additionally or alternatively be provided. That is, in various embodiments, the processing and computer storage capabilities can be onboard, offboard, or some combination thereof. For example, some processor and/or memory functions could be distributed across the supervisor 200, other vehicles, and/or other systems external to the robotic vehicle 100.

The functional elements of the robotic vehicle 100 can further include a navigation module 170 configured to access environmental data, such as the electronic map, and path information stored in memory 12, as examples. The navigation module 170 can communicate instructions to a drive control subsystem 120 to cause the robotic vehicle 100 to navigate its path within the environment. During vehicle travel, the navigation module 170 may receive information from one or more sensors 150, via a sensor interface (I/F) 140, to control and adjust the navigation of the robotic vehicle. For example, the sensors 150 may provide 2D and/or 3D sensor data to the navigation module 170 and/or the drive control subsystem 120 in response to sensed objects and/or conditions in the environment to control and/or alter the robotic vehicle's navigation. As examples, the sensors 150 can be configured to collect sensor data related to objects, obstructions, equipment, goods to be picked, hazards, completion of a task, and/or presence of humans and/or other robotic vehicles. The robotic vehicle may also include a human user interface configured to receive human operator inputs, e.g., a pick or drop complete input at a stop on the path. Other human inputs could also be accommodated, such as inputting map, path, and/or configuration information.

A safety module 130 can also make use of sensor data from one or more of the sensors 150, including LiDAR scanners 154, to interrupt and/or take over control of the drive control subsystem 120 in accordance with applicable safety standard and practices, such as those recommended or dictated by the United States Occupational Safety and Health Administration (OSHA) for certain safety ratings. For example, if safety sensors, e.g., sensors 154, detect objects in the path as a safety hazard, such sensor data can be used to cause the drive control subsystem 120 to stop the vehicle to avoid the hazard.

In various embodiments, the robotic vehicle 100 can include a carriage actuation and position feedback system 270. The carriage actuation and position feedback system 270 can process sensor data from one or more of the sensors 150, such as carriage sensors 156, and generate signals to control one or more actuators that control the engagement portion of the robotic vehicle 100. For example, the carriage actuation and position feedback system 270 can be configured to robotically control the actuators 111 and carriage 113 to pick and drop payloads. In some embodiments, the carriage actuation and position feedback system 270 can be configured to control and/or adjust the pitch, yaw, and roll of the load engagement portion of the robotic vehicle 100, e.g., forks 110. In various embodiments, the carriage actuation and position feedback system 270 comprises an onboard hydraulics system including a closed-loop hydraulics controller that controls motion of the carriage and/or forks based on acquired sensor data, e.g., from the carriage sensor 156. The hydraulics system can be configured to utilize dense point cloud data to control the carriage and/or forks.

In example embodiments, the AMR 100 also includes an infrastructure localization system 250. The infrastructure localization system 250 can use at least one of the sensors 150 to acquire sensor data over multiple planes in the direction of the payload area 102 to assist in navigating to the pick location and localizing the payload to be picked at the pick location. For example, the infrastructure localization system 250 can utilize at least one carriage sensor 156 to acquire sensor data in the direction of the forks 110a, 110b, wherein the sensor data can be used during actuation of the forklift carriage 113 as it raises and lowers the forks to enable the infrastructure localization system 250 to identify an infrastructure from the sensor data. The AMR 100 further includes a carriage actuation and position feedback system 270 that is configured to acquire position, velocity, and acceleration data of the forklift carriage. In various embodiments, movement of the carriage triggers the carriage actuation and position feedback system to acquire position, velocity, and/or acceleration data of the carriage. In some embodiments, the AMR 100 can further include a passive sensor deployment system 260 configured to operatively deploy the carriage sensor 156 at a predetermined height using onboard actuators in response to movement of the carriage 113 and/or forks 110a, 110b.

The infrastructure localization system can be configured to combine the sensor data from the multiple planes into the dense point cloud data based at least in part on the position, velocity, and/or acceleration data of the carriage. A sensor used to provide payload sensor data, such as carriage sensor 156, is movable, and the infrastructure localization system 250 is configured to provide interpolation of carriage position to determine sensor position for each scan and to provide transformation of individual point cloud poses to a common frame of reference.

Point cloud data can be determined from at least one sensor, such as a 3D sensor. A 3D sensor can be a 3D camera, a stereo camera, and/or a 3D LiDAR, as examples. Point cloud data is sensor data represented as 3D Cartesian points (X, Y, Z) computed by sampling the surfaces of objects in a scene. The fidelity of the scene reconstruction is, among other implementation factors, directly related to the point cloud density.

According to various embodiments, a point cloud is generated from one or more sensors 150 to enable precise infrastructure localization, but without adding additional hardware that would drive up COGS and complexity. In various embodiments, the system uses an existing actuator that is already in use for an existing process (lifting payloads) and leverages existing actuation in the process to collect the data while moving.

The passive system deployment system 260 includes a mechanical linkage which passively triggers sensor deployment when it reaches a certain height; the carriage sensor 156 is in a single fixed pose (location and orientation) on the truck. The system detects when the carriage sensor 156 is completely deployed. Then, the forklift carriage 113 is actuated, of which the system is able to track the position, velocity, and acceleration using the carriage actuation and position feedback system 270. The infrastructure localization system 250 provides interpolation of carriage position to determine sensor position for each scan. The density of points along each LiDAR ring and an aggregation of consecutive scans are used so a dense cloud is provided to fill in the elevation gaps inherent in this type of sensor. The infrastructure localization system 250 provides transformation of individual point cloud poses to a common frame. This allows salient features of the infrastructure, such as edges, which are otherwise missed in a single scan, to be reliably detected. The actuation speed is correlated with the sensor's data collection in order to minimize motion artifacts.

An additional benefit of the system is that the sensor signal can be used for multiple tasks, such as infrastructure detection, obstacle detection, free space detection, and apron detection. By avoiding a complex actuation mechanism COGS is controlled.

In various embodiments, the system can be implemented on a general-purpose Linux computer, using open source packages. In some embodiments, the system can be implemented using the tf2 ROS package. In various embodiments, 3rd party sensors, such as the Ouster OSO-128, can be used, but the inventive concepts are not limited to such sensors. Any type of sensor that returns range data (not necessarily LiDAR) may be used. Other sensors could be used in other embodiments. The system could implement other types of processors, environments, and computer program code.

A system as described in the related U.S. Provisional Patent Application 63/324,190, entitled “Passively Actuated Sensor Deployment,” which is incorporated herein by reference, discloses use of a system to deploy an object detection sensor to look beneath the forks, when the forks approach the floor level.

By leveraging existing vehicle actuators, the need for a separate actuator and corresponding feedback control system is eliminated. This reduces both hardware and software complexity, as well as system COGS.

The system according to various embodiments can be used by any system or subsystem that benefits from point cloud data in the payload area or forks-facing direction while stationary. For example, the systems as described in the related U.S. Provisional Patent Application 63/324,192, entitled “Automated Identification of Potential Obstructions In A Targeted Drop Zone,” related U.S. Provisional Patent Application 63/324,193, entitled “Localization of Horizontal Infrastructure Using Point Clouds,” and related U.S. Provisional Patent Application 63/324,198, entitled “Segmentation of Detected Objects Into Obstructions And Allowed Objects,” can leverage data collected by use of such a system, each of which is incorporated herein by reference.

According to various embodiments, the perception capabilities of a sensor are enhanced with no increase in COGS. The system generalizes the functionality of the sensor so it can be applied to a range of tasks such as industrial table detection, industrial rack detection, and obstruction detection to name but a few. This is accomplished through the generation of dense point clouds over greater fields of view (FOVs) which are otherwise unobtainable from a statically mounted sensor. Another benefit of the system is a reduction in the time of all payload drop operations.

A component of the carriage actuation and position feedback system 270 is a high-precision encoder, which provides the vertical position in the Z-axis of the forks to the floor my electro-mechanically measuring translation of the forks 110 relative to the carriage 113.

Although the encoder's purpose is for position and velocity control of the lift axis, it has the added benefit of giving real-time position data while the lift is in motion to move the forks. This position information, with the timestamp it received, is entered into the tf2 library, along with such information for other encoders. “tf2” is the second generation of the transform library, which lets the user keep track of multiple coordinate frames over time. tf2 maintains the relationship between coordinate frames in a tree structure buffered in time, and lets the user transform points, vectors, etc. between any two coordinate frames at any desired point in time.

When preparing to drop a load on a surface, such as a palletized load, the forks 110a,b must be lifted past the surface to some fixed height (a step required to clear any lips or guards at the table edge). While performing this actuation and tracking encoder data, point cloud data from a LiDAR sensor (e.g., the Ouster OSO-128 ultrawide field of view LiDAR sensor) is also being received along with corresponding timestamps. The data at a given timestamp is acquired and the tf2 library is used to transform the points into the same coordinate frame based on the known position at the time received. This is performed for all the data collected over the lift motion and the data is combined into one point cloud. The result is a much denser point cloud, particularly in the Z direction (vertical direction of lift actuation), where the sensor would otherwise have much sparser data if captured while stationary. There is also significantly greater coverage of the scene as a result of the vertical motion. In addition, careful spatiotemporal indexing enables precise and efficient accumulation of separate point clouds for point cloud features (e.g., planes, edges, etc.) without explicit accumulation of all the raw clouds.

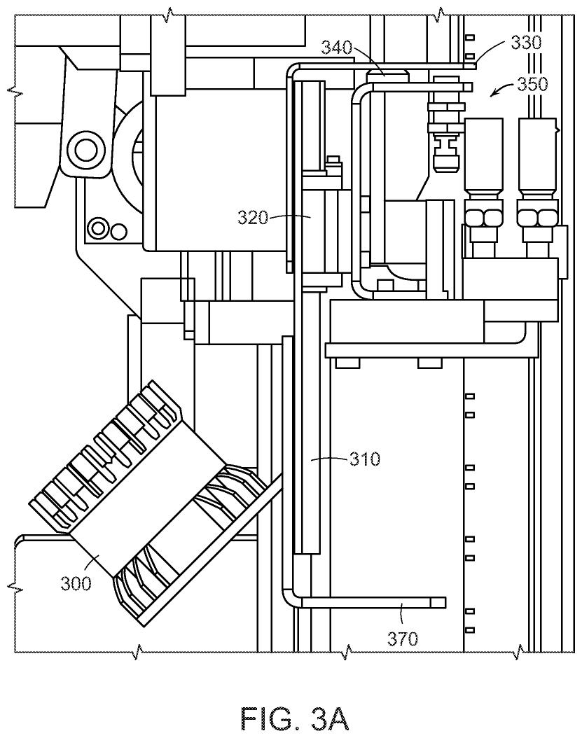

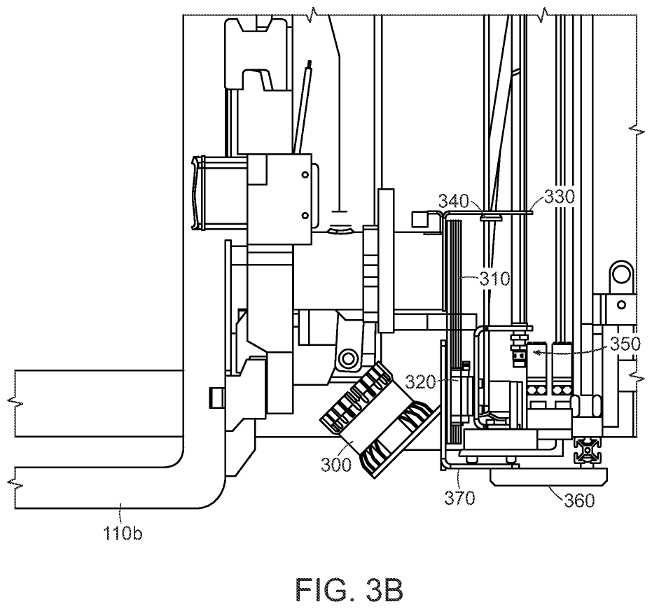

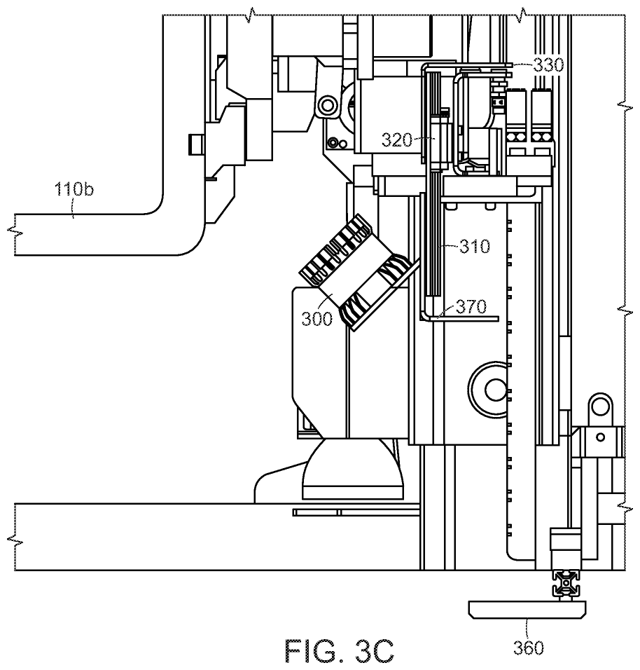

As seen in FIGS. 3A through 3C, embodiments of the passively actuated sensor deployment system 260, can include an actuation slide 310 and carriage 320 (like carriage 113), at least one carriage sensor 300 (like carriage sensor 156), a deployment hard stop 330, a magnet 340 on the deployment hard stop 330, a retracting hard stop 360, and an actuation position feedback sensor 350. In this embodiment, the sensor is coupled to a sensor mount 370. The sensor mount 370 is coupled to the slide 310 by, for example, bolts.

When retracted, the sensor 300 rests inside the mast above the forks 110a,b, as seen in FIG. 3A. When the forks 110a,b are lifted, the sensor 300 remains stationary while the mast actuation slide 310 moves until the deployment hard stop 330 is engaged. A position feedback sensor 350 confirms that the sensor 300 is fully deployed at a repeatable location relative to the forks 110a,b. A magnet 240 is used on the deployment hard stop 330 to prevent the sensor 300 from bouncing up and down during operation. The sensor 300 will move upward and downward with the forks 110a,b as long as the sensor 300 does not make contact with the retracting hard stop 360. The sensor 300 is deployed far enough below the forks 110a,b that it is not obstructed by robotic vehicle 100, forks 110a,b or payload 106 and provides an unobstructed view under, behind and below the raised forks 110a,b.

To retract the sensor 300, the forks 110a,b are lowered until the sensor 300 makes contact with the retracting hard stop 360. The forks 110a,b will continue to move downward causing the deployment hard stop 330 to no longer make contact and the position feedback sensor 350 will no longer be active. The forks 110a,b can be lowered to the ground while the sensor 300 remains stationary inside the mast.

The sensor 300 provides data to improve the robotic vehicle's 100 awareness of the environment during travel and payload operations. According to various embodiments, the passively actuated sensor system provides a view behind the forks 110a,b when the robotic vehicle 100 is traveling in a forks-forward direction in order to detect potential obstacles when the forks 110a,b are at payload carry height. According to various embodiments, the system allows the sensor 300 to scan for the front of a shelf/table (also known as apron detection) to allow the robotic vehicle 100 to closely approach a payload pickup/drop location and getting the outriggers 108 very close to the table structure for load transactions. According to various embodiments, the system allows the sensor 300 to scan for the surface of a shelf/table (also known as free space checking) to assure the area is free of obstacles or other payloads in placement and determine the best location to place the payload.

According to various embodiments, the sensor 300 is retracted into the mast of the robotic vehicle 100 when the forks 110a,b are lowered to the floor. The sensor 300 remains in the retracted position until the forks 110a,b have reached a predetermined height, which is sensed by the position feedback sensor 350, and the deployment hard stop 330 is engaged. The hard stop 330 defines a physical termination to the path of the carriage 320. At which point, the sensor 300 moves upward and downward with the forks 110a,b until the sensor 300 makes contact with the retracting hard stop 360. When the sensor 300 makes contact with the retracting hard stop 360, the sensor 300 is retracted into the mast of the AMR 100.

In various embodiments, the sensor 300 is positioned such that it is angled downward between the forks 110a,b, so when the sensor 300 is lifted above the surface, a very dense collection of points is provided when a ‘scan’ over the top horizontal surface is performed. FIG. 3C illustrates the location of the sensor 300 when in the deployed position is at a level under the fork tines. In some embodiments, the sensor is located above the forks when the forks are lowered. This location allows a view of the space under and behind the forks 110a,b that is not occluded when a payload is present. When the payload is present on a surface, e.g., a palettized load on a table or shelf, the sensor 300 is arranged to collect dense point cloud data beneath the forks (and payload) to confirm a drop off area is clear of obstructions for the drop off.

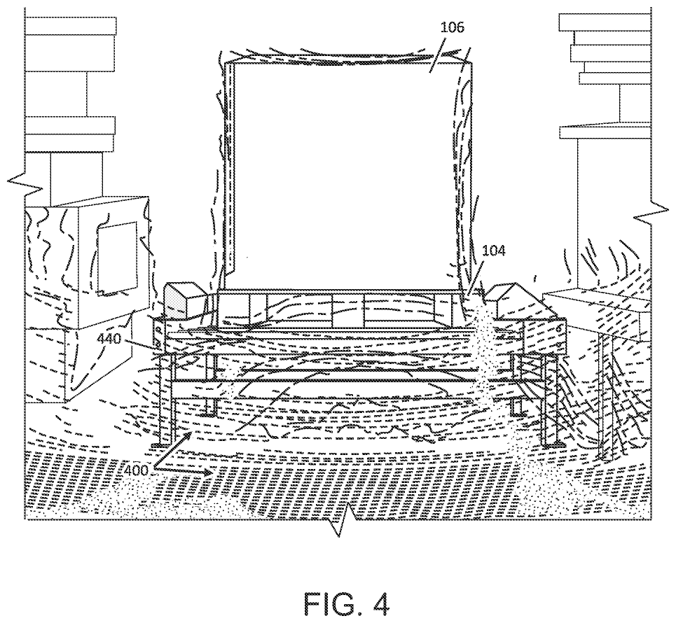

FIG. 4 illustrates the horizontal scan planes 400 that produce dense point cloud data from the sensor 300, for example, e.g., the Ouster OSO-128, passing over the face of the table 440, pallet 104, and payload 106 while the lift is being actuated upwards. The dense point cloud data is superior to a stationary capture that might have the leading edge of the table between planes, giving poor indication of the table face, and the point density is higher than a stationary capture. However, the scanning in accordance with the inventive concepts ensures points up the vertical face to the edge are captured, then along the horizontal surface traveling inward. The effect of the greater scene coverage is also apparent as the pallet face and payload are initially not in the sensor's field of view.

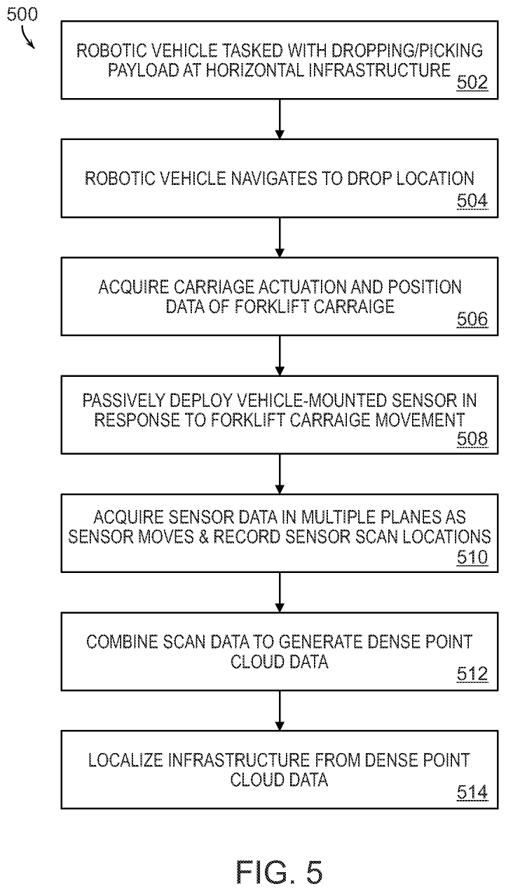

FIG. 5 is a block diagram of a method 500 of localizing infrastructure using dense point cloud data from a vehicle-mounted actuatable sensor, in accordance with the inventive concepts. In step 502, the robotic vehicle 100 is tasked with dropping or picking a payload at a location. In step 504, the robotic vehicle navigates to that location. At the location, in step 506, the robotic vehicle acquires carriage actuation and position data of the forklift carriage, in an AMR forklift embodiment. In step 508, the robotic vehicle moves the forks, e.g., above a horizontal surface used to pick or drop a payload, and passively deploys the vehicle-mounted sensor, e.g., carriage sensor 156 in response to the forklift carriage movement. As the forklift carriage and the sensor move, the sensor takes multiple scans of point cloud data and the scan location, e.g., height above the floor, is recorded for each scan plane, in step 510. In step 512, the point cloud data from each scan is combined into dense point cloud data. And in step 514, using the dense point cloud data, the robotic vehicle localizes the scanned infrastructure, e.g., a table, rack, or other surface. The dense point cloud data may also be used to determine obstructions that would prevent picking/dropping a payload on the infrastructure. To localize the infrastructure, the robotic vehicle can use the dense point cloud data for edge detection and determine salient features of the scanned infrastructure based on the detected edges.

In various embodiments, a system according to the inventive concepts generates a dense point cloud in a common coordinate frame from one or more sparse sensors. The system includes a passive sensor deployment mechanism; one or more general-purpose computers; a multi-ring LiDAR sensor; carriage actuation and position feedback; a closed-loop control of hydraulics; clock synchronization via precision time protocol (PTP); interpolation of carriage position to determine sensor position for each scan; transformation of individual point cloud poses to a common frame.

While the foregoing has described what are considered to be the best mode and/or other preferred embodiments, it is understood that various modifications may be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

1. An autonomous mobile robot (AMR), comprising:
a carriage actuation and feedback system configured to robotically control a carriage to control a height of a pair of forks;
at least one sensor configured to acquire sensor data over multiple planes in a direction of the forks during actuation of the carriage that raises and lowers the forks, wherein the at least one sensor includes a sensor that is located between the forks; and
an infrastructure localization system configured to combine the sensor data from the multiple planes into dense point cloud data and identify an infrastructure from the dense point cloud data.

2. The robot of claim 1, wherein the infrastructure localization system is configured to transform sensor data for individual poses of the infrastructure to a common frame of reference to combine the sensor data from the multiple planes.

3. The robot of claim 1, wherein the at least one sensor includes a sensor that is downwardly directed to acquire the sensor data beneath the raised forks.

4. The robot of claim 3, wherein the carriage actuation and feedback system includes a hard stop that sets a lower limit for the height of the at least one sensor when the forks are raised.

5. The robot of claim 1, wherein the at least one sensor includes a sensor that is located beneath the raised forks.

6. The robot of claim 5, wherein the at least one sensor includes a sensor that is located above the forks when the forks are lowered.

7. The robot of claim 1, wherein the at least one sensor comprises a multi-ring LiDAR sensor.

8. The robot of claim 1, further comprising a passive sensor deployment system configured to operatively move the at least one sensor in response to movement of the forks.

9. The robot of claim 1, wherein movement of the carriage triggers the carriage actuation and position feedback system to acquire position, velocity, and/or acceleration data of the carriage, and
wherein the infrastructure localization system is configured to combine the sensor data from the multiple planes into the dense point cloud data based at least in part on the position, velocity, and/or acceleration data of the carriage.

10. The robot of claim 1, wherein the carriage actuation and position feedback system comprises a closed-loop hydraulics controller.

11. The robot of claim 1, wherein the infrastructure localization system is configured to provide interpolation of carriage position to determine sensor position for each scan.

12. A method of localizing infrastructure in an autonomous mobile robot (AMR), comprising:
providing an AMR having a pair of forks coupled to a carriage that is height adjustable and at least one sensor oriented in the direction of the forks, wherein the at least one sensor includes a sensor that is located between the forks;
acquiring sensor data in multiple planes with the at least one sensor during actuation of a forklift carriage that raises and lowers the forks; and
combining the sensor data from the multiple planes into dense point cloud data and identifying an infrastructure from the dense point cloud data.

13. The method of claim 12, further comprising transforming sensor data for individual poses of the infrastructure to a common frame of reference to combine the sensor data from the multiple planes.

14. The method of claim 12, wherein the at least one sensor includes a sensor that is downwardly directed to acquire the sensor data beneath the raised forks.

15. The method of claim 12, wherein the AMR includes a hard stop that sets a lower limit for the height of the at least one sensor when the forks are raised.

16. The method of claim 12, wherein the at least one sensor includes a sensor that is located beneath the raised forks.

17. The method of claim 16, wherein the at least one sensor includes a sensor that is located above the forks when the forks are lowered.

18. The method of claim 12, or any other claim or combination of claims, wherein the at least one sensor comprises a multi-ring LiDAR sensor.

19. The method of claim 12, further comprising passively deploying the at least one sensor using onboard actuators in response to movement of the forks.

20. The method of claim 12, further comprising, in response to movement of the carriage, acquiring position, velocity, and/or acceleration data of the carriage, and
wherein combining the sensor data from the multiple planes into the dense point cloud data based at least in part on the position, velocity, and/or acceleration data of the carriage.

21. The method of claim 12, further comprising controlling the carriage height based on the sensor data with a closed-loop hydraulics controller.

22. The method of claim 12, further comprising interpolating carriage position to determine sensor position for each scan.
